(19) United States
(12) Patent Application Publication
(10) Pub. No.: US 2023/0077203 A1
(43) Pub. Date: Mar. 9, 2023

(54) ASSEMBLY AND DISPLAY OF NONSTANDARD PRODUCT SPECIFICATIONS

(71) Applicant: International Business Machines Corporation, Armonk, NY (US)

(72) Inventors: Mandar Dattatraya Bhuvad, Pune (IN); Nitesh Jankilal Shreemali, Pune (IN); Manish Madhukarrao Tumbde, Pune (IN)

(21) Appl. No.: 17/465,154

(22) Filed: Sep. 2, 2021

(51) Int. Cl. G06Q 30/06

(52) U.S. Cl. CPC G06Q 30/0621; G06Q 30/0635; G06Q 30/0627; G06Q 30/0603

(57) ABSTRACT

Computer technology for selecting content and/or ordering content from a full version of a product specification to make a customized version of the product specification for a requester that has requested a product specification. This customization of the product specification is based at least in part on “context information,” which means any information relevant to the requester's expected use of the product specification except for information that the requester put into the request (for example, if the request includes a search query, that search query would not qualify as “context information”).

### BACKGROUND

The present invention relates generally to e-commerce platforms (such as large and small online retailers), and also to the field of presentation of relevant product information to users who want to learn about relevant attributes of a product.

Product specifications are known. An example of a product specification will now be set forth:

APPLE PIE SPECIFICATION FOR ABC PIE CO.:

| | |
|---|---|
| PIE DIAMETER: | 10.75 inches at pie top surface |
| TOTAL PIE DEPTH: | 2 inches |
| PIE FILLING DEPTH: | 1 inch |
| LATERAL TAPER ANGLE: | 55 degrees from pie base |
| PIE DISH MATERIAL: | 100% aluminum with anodized surface |
| TOP CRUST: | Flakey & Crumble Varieties Available |
| APPLE VARIETAL MIX: | 50 percent Fuji, 50 percent Macintosh |
| NUMBER OF CALORIES: | 8000 calories per pie |
| SODIUM: | 1.5 grams per pie |

As can be seen from this simple example, the substantive content of product specification is made up of parameters (for example, pie dish material) and parameter values (for example aluminum). Parameter values may be numerical or non-numerical. Parameters may be subjective in nature (for example, average customer rating out of five stars maximum) or objective in nature (for example, product length expressed in inches).

### SUMMARY

According to an aspect of the present invention, there is a method, computer program product and/or system that performs the following operations (not necessarily in the following order): (i) receiving a product specification data set that includes information indicative a full version of a product specification, with the full version of the product specification including information indicative of: (a) an identification of a first product, (b) an identification of a plurality of parameters associated with the first product, and (c) for each parameter of the plurality of parameters, a respectively corresponding parameter value that characterizes the first product with respect to the given parameter; (ii) receiving, from a user and through a communication network, a user request for the product specification; (iii) collecting user context information which includes information that is: (a) relevant to the user's likely interactions with the product specification, and (b) not included in the user request; (iv) selecting, by machine logic and based at least in part on the user context information, a plurality of selected parameters from the plurality of parameters; and (v) assembling, by machine logic, a customized version of the product specification that includes only the selected parameters and selected parameter values.

According to an aspect of the present invention, there is a method, computer program product and/or system that performs the following operations (not necessarily in the following order): (i) receiving a service specification data set that includes information indicative a full version of a service specification, with the full version of the service specification including information indicative of: (a) an identification of a first service, (b) an identification of a plurality of parameters associated with the first service, and (c) for each parameter of the plurality of parameters, a respectively corresponding parameter value that characterizes the first service with respect to the given parameter; (ii) receiving, from a user and through a communication network, a user request for the service specification; (iii) collecting user context information which includes information that is: (a) relevant to the user's likely interactions with the service specification, and (b) not included in the user request; (iv) selecting, by machine logic and based at least in part on the user context information, a plurality of selected parameters from the plurality of parameters; and (v) assembling, by machine logic, a customized version of the service specification that includes only the selected parameters and selected parameter values.

According to an aspect of the present invention, there is a method, computer program product and/or system that performs the following operations (not necessarily in the following order): (i) receiving a product/service (P/S) specification data set that includes information indicative a full version of a P/S specification for a combination of product(s) and service(s), with the full version of the P/S specification including information indicative of: (a) an identification of a first service, (b) an identification of a plurality of parameters associated with the first service, and (c) for each parameter of the plurality of parameters, a respectively corresponding parameter value that characterizes the combination of product(s) and service(s) with respect to the given parameter; (ii) receiving, from a user and through a communication network, a user request for the P/S specification; (iii) collecting user context information which includes information that is: (a) relevant to the user's likely interactions with the P/S specification, and (b) not included in the user request; (iv) selecting, by machine logic and based at least in part on the user context information, a plurality of selected parameters from the plurality of parameters; and (v) assembling, by machine logic, a customized version of the P/S specification that includes only the selected parameters and selected parameter values.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system;

FIG. 4 is a screenshot view generated by the first embodiment system; and

FIG. 5 is a flowchart showing a second embodiment of a method according to the present invention.

### DETAILED DESCRIPTION

Some embodiments of the present invention are directed to computer technology for selecting content and/or ordering content from a full version of a product specification to make a customized version of the product specification for a requester that has requested a product specification. This customization of the product specification is based at least in part on “context information,” which means any information relevant to the requester's expected use of the product specification except for information that the requester put into the request (for example, if the request includes a search query, that search query would not qualify as “context information”). This Detailed Description section is divided into the following subsections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product at any possible technical detail level of integration. The computer program product may include a computer readable storage medium (or media) having computer readable program instructions thereon for causing a processor to carry out aspects of the present invention. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

A “storage device” is hereby defined to be anything made or adapted to store computer code in a manner so that the computer code can be accessed by a computer processor. A storage device typically includes a storage medium, which is the material in, or on, which the data of the computer code is stored. A single “storage device” may have: (i) multiple discrete portions that are spaced apart, or distributed (for example, a set of six solid state storage devices respectively located in six laptop computers that collectively store a single computer program); and/or (ii) may use multiple storage media (for example, a set of computer code that is partially stored in as magnetic domains in a computer's non-volatile storage and partially stored in a set of semiconductor switches in the computer's volatile memory). The term “storage medium” should be construed to cover situations where multiple different types of storage media are used.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

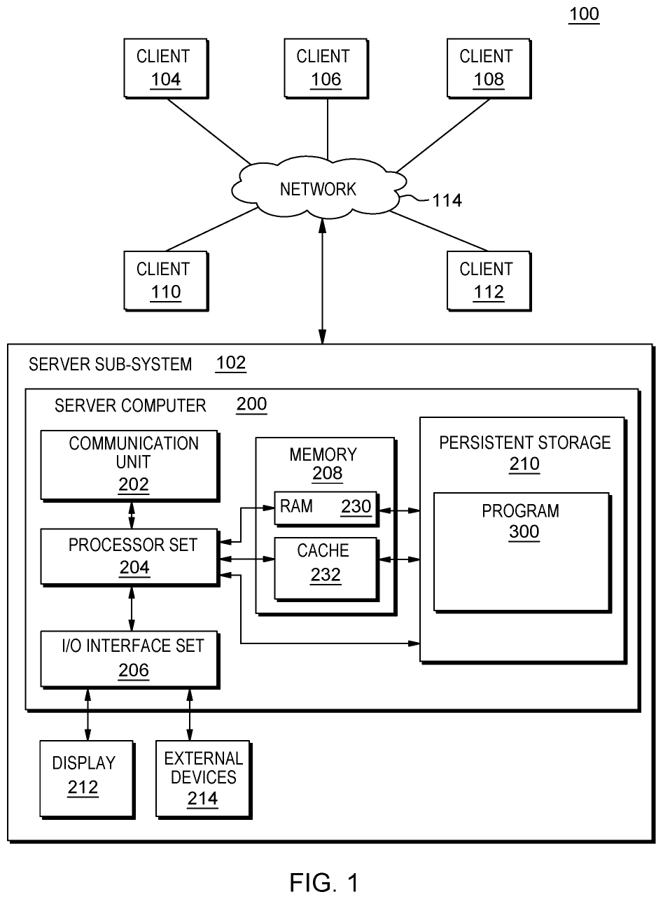

As shown in FIG. 1, networked computers system 100 is an embodiment of a hardware and software environment for use with various embodiments of the present invention. Networked computers system 100 includes: server subsystem 102 (sometimes herein referred to, more simply, as subsystem 102); client subsystems 104, 106, 108, 110 and 112; and communication network 114. Server subsystem 102 includes: server computer 200; communication unit 202; processor set 204; input/output (I/O) interface set 206; memory 208; persistent storage 210; display 212; external device(s) 214; random access memory (RAM) 230; cache 232; and program 300.

Subsystem 102 may be a laptop computer, tablet computer, netbook computer, personal computer (PC), a desktop computer, a personal digital assistant (PDA), a smart phone, or any other type of computer (see definition of “computer” in Definitions section, below). Program 300 is a collection of machine readable instructions and/or data that is used to create, manage and control certain software functions that will be discussed in detail, below, in the Example Embodiment subsection of this Detailed Description section.

Subsystem 102 is capable of communicating with other computer subsystems via communication network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client subsystems.

Subsystem 102 is shown as a block diagram with many double arrows. These double arrows (no separate reference numerals) represent a communications fabric, which provides communications between various components of subsystem 102. This communications fabric can be implemented with any architecture designed for passing data and/or control information between processors (such as microprocessors, communications and network processors, etc.), system memory, peripheral devices, and any other hardware components within a computer system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for subsystem 102; and/or (ii) devices external to subsystem 102 may be able to provide memory for subsystem 102. Both memory 208 and persistent storage 210: (i) store data in a manner that is less transient than a signal in transit; and (ii) store data on a tangible medium (such as magnetic or optical domains). In this embodiment, memory 208 is volatile storage, while persistent storage 210 provides nonvolatile storage. The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202 provides for communications with other data processing systems or devices external to subsystem 102. In these examples, communications unit 202 includes one or more network interface cards. Communications unit 202 may provide communications through the use of either or both physical and wireless communications links. Any software modules discussed herein may be downloaded to a persistent storage device (such as persistent storage 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. I/O interface set 206 also connects in data communication with display 212. Display 212 is a display device that provides a mechanism to display data to a user and may be, for example, a computer monitor or a smart phone display screen.

In this embodiment, program 300 is stored in persistent storage 210 for access and/or execution by one or more computer processors of processor set 204, usually through one or more memories of memory 208. It will be understood by those of skill in the art that program 300 may be stored in a more highly distributed manner during its run time and/or when it is not running. Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

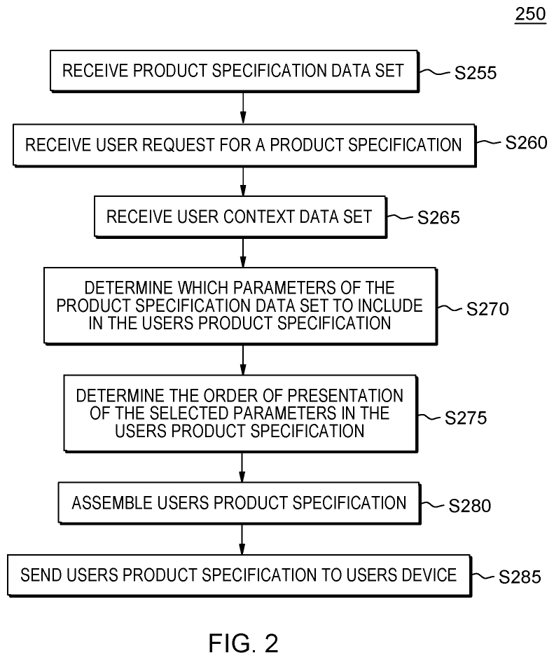

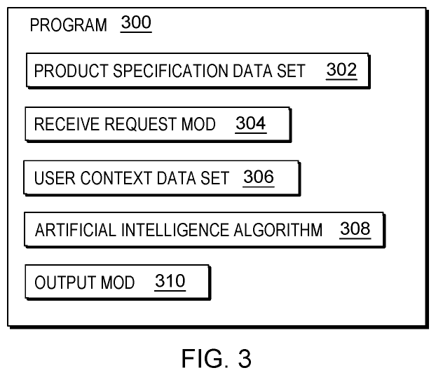

As shown in FIG. 1, networked computers system 100 is an environment in which an example method according to the present invention can be performed. As shown in FIG. 2, flowchart 250 shows an example method according to the present invention. As shown in FIG. 3, program 300 performs or controls performance of at least some of the method operations of flowchart 250. This method and associated software will now be discussed, over the course of the following paragraphs, with extensive reference to the blocks of FIGS. 1, 2 and 3.

Processing begins at operation S255, where product specification data set 302 is received. Data set 302 includes information indicative of the following: (i) identification of a product; (ii) identification of a plurality of parameters (sometimes may also be herein referred to as attributes); and (iii) a plurality of parameter values respectively corresponding to the parameters. In this example, the identification of the product to which data set 302 relates is as follows: Widget Model A. Alternatively, data set 302 could be directed to a service, instead of a product, or even directed to a package that includes both product(s) and service aspect(s). In this example, program 300 is an e-commerce platform where end users can purchase products and/or services. In this example, data set 302 comes through network 114 from client subsystem 104. Client subsystem 104 is an enterprise computer system of a manufacturer called The Widget Store. In this example, The Widget Store is the manufacturer of Widget Model A, and The Widget Store sells the Widget Model A product to the following types of customer: (i) retail customers (also herein referred to as end users); and (ii) wholesale customers (for example, big box retail stores). Program 300 is an e-commerce platform that includes both wholesale and retail customers, and which regularly arranges for sales of the Widget Model A product to both types of customers. It is noted that program 300 knows whether a given shopper is a retail or wholesale customers—these two customer types use different portions of the e-commerce platform of program 300 when they shop there.

Here is the full version of the product specification corresponding to data set 302 (with the order of the parameters in this listing establishing a “default ordering” for displaying the parameters of the product spec):

WIDGET MODEL A, 1 Aug. 2021, FULL VERSION

| | |
|---|---|
| HEIGHT: | 110 MILLIMETERS |
| COLOR: | RED |
| EFFECTIVE CLEARANCE: | 1.2 MILLIMETERS |
| FLUX CAPACITANCE: | NONE |
| RECYCLABLE: | YES |
| PRICE: | $13.98 USD |
| WHOLESALE PRICE: | $13.84 usd |
| WIDGETS PER PALLETTE: | 106 |
| SHIPPING HAZARD CLASS: | M LEVEL OR BETTER |

As can be seen from this full version of the product specification, it includes ten (10) parameters and ten (10) associated parameter values.

Processing proceeds to operation S260, where receive request module (“mod”) 304 receives a user request for a product specification. In this example, the request comes through network 114 from client subsystem 106, which is the smartphone of a retail customer, who, in this example, happens to be desirous of buying a Widget Model A product, through the e-commerce platform of program 300, for use in her home and office.

Processing proceeds to operation S265, where user context data set 306 is received. The user context includes a plurality of information (facts and/or opinion) that might possibly be relevant to the end user of client subsystem 106 (the party who submitted the user request at operation S106) potentially purchasing Widget Model A through the e-commerce platform of program 300. In this example, the user context data includes information about: (i) who the customer is (for example, the requester here is a retail customer who is 63 years of age); (ii) who the manufacturer of the product is; (iii) who the delivery service is that would deliver the product; (iv) geographic and location information related to the customer, supplier and or delivery entity (for example, the end user is located in a hot, dry climate); (v) temporal information related to the customer, supplier and or delivery entity (for example, based on time of year, it is believed that the customer is doing Holiday shopping for gifts for other people); and (vi) the customers previous purchases of Widget Model A and/or other competitive products that may substitute for Widget Model A. As those of skill in the art will appreciate, many types of data may act as context data, and the foregoing examples of certain types of possible user context information shall not be considered as limiting.

Processing proceeds to operation S270, where artificial intelligence algorithm 308 determines which parameters of the product specification data set to include in the users product specification based at least in part on the information included in user context data set 306. In this example, all of the retail customers, like the end user at client subsystem 106, get the same abbreviated version of the product specification as follows:

WIDGET MODEL A, 1 Aug. 2021, RETAIL VERSION

| | |
|---|---|
| HEIGHT: | 110 MILLIMETERS |
| COLOR: | RED |
| EFFECTIVE CLEARANCE: | 1.2 MILLIMETERS |
| FLUX CAPACITANCE: | NONE |
| RECYCLABLE: | YES |
| PRICE: | $13.98 USD |
| WEIGHT: | 1.15 KILOGRAMS |

This abbreviated version for retail customers, as determined by AI algorithm 308, includes only seven (7) of the original ten (10) parameters of the full version. AI algorithm 108 has also generated an abbreviated version of the product spec for use with wholesale customers, and this version cuts out parameters that are unlikely to be of interest to a typical wholesale customer.

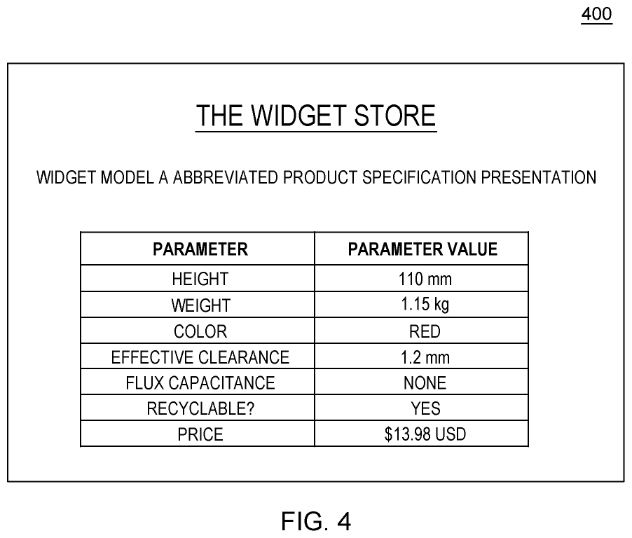

Processing proceeds to operation S275, where artificial intelligence algorithm 308 determines the order of presentation of the selected parameters in a final version of the product specification that has been assembled for the retail customer at client subsystem 106. As shown in screenshot 400 of FIG. 4, the order has been changed, relative to the default ordering, because weight has been moved up from being the last displayed parameter to the second displayed parameter. In this example, the reason for the reordering is that the light weight of Widget Model A is an important and valuable features for a relatively large proportion of end users over age 60 years.

Processing proceeds to operation S280, where output mod assembles a data set according to the final version as previously determined at operations S270 and S275.

Processing proceeds to operation S285, where output mod 310 sends the data set corresponding to the final version of the Widget Model A Product Specification, generated for the retail customer at client subsystem 106, over network 114 and to client subsystem 106 where it is displayed in a scrollable manner of the screen of the smartphone. This display of the final version of the product specification is shown at screenshot 400.

Some embodiments of the present invention do not require the user to enter any sort of query. For example, in the example of low chart 250, discussed directly above, the user requests a product specification as part of shopping on an e-commerce platform, but the user does not enter a query to specify the manner in which various parameters of the product spec are selected/not-selected for presentation and also the manner in which the various parameters are ordered. In other words, in some embodiments, the user does not need to raise a query related to Product specification. In some embodiments of the present invention, the system is using AI modelling to understand the users' requirement from current context to identify the non-standard specification requirement. Using existing customer's responses and feedbacks, the system generates a non-standard product specification (not a part of standard product description) along with its possible values and make it available to that specific user. This nonstandard Product specification will only be visible to user in the context.

Some embodiments of the present invention are based on context identification for specific requirement from the communication.

Some embodiments of the present invention generate a new nonstandard product specification along with possible values using: (i) an identified context; and/or (ii) existing customer's reviews, feedback, and the like.

In some embodiments of the present invention, the technique of context identification determines, at least in some part, the relevant topic or subject (current context) using several factors like by identifying key terms or phrases from the discussion between two or multiple parties, from text, from a situation, media context, and the like.

As used in this document, the term “non-standard product specification” is hereby defined as a product specification that is constructed after we know the identity of the party requesting to look at the product specification. On the other hand, a standard product specification is created before it is requested by a requester, and the same product information is given to all requesters, regardless of who the requester is.

Some embodiments of the present invention generate a new nonstandard product specification by consideration of a current context. Some embodiments generate a non-standard product specification and its possible Type and Index value from the identified current context.

Some embodiments of the present invention avoid operations of: (i) collating (that is, searching for, finding and collecting) information from standard specifications available on various websites; and (ii) compiling these multiple standard product specifications to the local database based on a user's query. These operations are avoided because some embodiments of the present invention receive a single “full version” of the product specification (see operation S255, discussed above) and then customize for a given requester exclusively using information from the single full version, rather than from a plethora of sources scattered at various endpoints all over the internet.

A use case, reflecting an embodiment of the present invention, will now be discussed in the following paragraphs.

If a person plans to buy a mattress online and searches for a suitable one. The specification what she/he can view online for any mattress product usually are their Standard Specification and its Values. Like Mattress Size—King Size, Queen Size, 71*71 Inch, etc., Color—White, Black, Red, etc., Print Type—Floral, Sky, Heart, etc., Material Type—Breathable Fabric, Memory Foam, Spring Mattress etc., Thickness—4 inch, 5 Inch, 6 Inch, etc., Warranty etc. Now these specifications are defined by the Manufacturing Company or the seller, here referred as Standard Product Specifications. These are available across various websites.

The embodiment of the present invention currently under discussion considers, and takes into account, that this person has slip disk problem and is not sure which product to purchase for comfort. The prospect is not sure whether a specific mattress type to be purchased can provide him/her the relaxation she/he is looking for to his/her back pain. Now this product for example has 1000+ customer reviews. Based on this specific requirement, the system will review all customer feedback and dynamically generate a Non-Standard Product Specification (not provided by manufacturing company/seller) say ‘Relief in Slip Disk’ along with its possible values Excellent Relief, Marginal Relief, Poor Relief. This newly generated non-standard product specification will only be made available for that prospect and not others who are viewing the same product on same Website. This will help prospect make appropriate decision based on his personal requirement.

### III. Further Comments and/or Embodiments

Some embodiments of the present invention recognize the following facts, potential problems and/or potential areas for improvement with respect to the current state of the art: (i) in today's digital era, and also due to factors like pandemic(s), consumers more and more prefer to shop online as a primary channel for their purchases; (ii) advanced AI (artificial intelligence) infusion is a key factor in improving the consumer's shopping experience and decision making that contributes to exponential growth of e-commerce business; and/or (iii) online businesses are still facing challenges such as providing the prospect a real look and feel of the product, standard nonstandard product specifications, quality, trust, supply chain challenges, etc.

Some embodiments of the present invention recognize the following facts, potential problems and/or potential areas for improvement with respect to the current state of the art: (i) one major challenge for online e-commerce businesses is to show the full product specification or item description that are specific to the product; (ii) item descriptions shows standard specifications such as model number, weight, color, size, brand, dimensions, etc.; (iii) mostly all of the specifications are standard item descriptions and may not provide enough information to the prospect to decide on the purchase of that product; (iv) eventually prospects end up reviewing the feedback comments and/or try to find specific information from either the service provider or from other sources because the nonstandard specification is the important decisive factor for that prospect to complete the purchase; and/or (v) information gathering becomes time-consuming and an exhaustive task that adversely impacts the prospects decision and e-commerce businesses as well.

Some embodiments of the present invention may include one, or more, of the following operations, features, characteristics and/or advantages: (i) includes an AI based intelligent system that provides an enhanced e-commerce platform which learns from the prospects context during product review; (ii) displays the required nonstandard product specifications, specific to that prospect; (iii) the nonstandard product specification will only be visible to the specific prospect and will not be displayed to any other prospect reviewing the same product at the same time and to the same prospect with different context at a different time (for example, it will change dynamically with respect to the context of the prospect); and/or (iv) the system will learn from real time events like the prospect's current comments, conversations, discussions, and other relevant references currently available with the prospect during product review.

Some embodiments of the present invention may include one, or more, of the following operations, features, characteristics and/or advantages: (i) nonstandard product specifications will be generated using AI NLP (natural language processing) by identifying the need and relating it to the product feature to generate the specification; (ii) the system will analyze other consumer reviews and predefined hidden item descriptions to establish the relation between newly identified nonstandard product specifications and its possible types and values; (iii) the above information will then be supplemented with a nonstandard unit to make it understandable to the prospect; and/or (iv) there will be a direct impact on the prospect's decision making that will help the prospect to complete the purchase and directly help businesses to improve customer satisfaction.

Some embodiments of the present invention may include one, or more, of the following operations, features, characteristics and/or advantages: (i) the system learns the prospects requirements using AI services like NLP in real-time from the current context during the product evaluation on the e-commerce platform; (ii) uses the requirements noted above to create a nonstandard product specification to be displayed; (iii) the system uses existing feedbacks, reviews, and relevant references from other consumers to generate a type and index value for the nonstandard product specifications, as described above, using data science services such as cluster analysis; and/or (iv) the type and index value for nonstandard product specifications as mentioned above would be dynamically displayed to a specific prospect without making it available for generalized visibility.

Some embodiments of the present invention may include one, or more, of the following operations, features, characteristics and/or advantages: (i) includes nonstandard product specifications based on the current context and real time requirements from the user during review; (ii) continuously learns the prospects comments, colloquial language, and discussion with friends/family during product review in real-time using AI NLP to convert that to a meaningful product specification; (iii) searches the predefined item description and other consumers feedback to generate a nonstandard product specification that is most suitable for the specific prospect; (iv) the system learns the prospects requirement using AI services such as NLP in real-time from the current context during the product evaluation on the e-commerce platform; and/or (v) using that requirements noted above, creates a nonstandard product specification to be displayed.

According to some embodiments of the present invention, the items described in the above paragraph will now be discussed as an example in the following three (3) paragraphs.

Prospect A and his/her friend B are searching for a hotel room for a family holiday. They are reviewing hotel rooms on e-commerce platform travel websites. While searching for the hotel, normally travel website platforms display hotel specifications in terms of location, distance from the airport/railway station, amenities, room size, pool, beach front, and food menu as part of the standard product description. Additionally, they also show pictures from professionals, pictures from visitors, reviews, feedback, etc. to attract the prospect to book the hotel. At times, a few travel website platforms will also display alerts such as “number of people looking at this hotel”, “only 5 rooms left” etc. to positively impact the prospects decision to complete the transaction.

In this scenario, prospect A has selected hotel XYZ and is about to confirm the booking. However, prospect B casually comments that “he/she is suffering from a backache and the doctor has suggested him/her to sleep on a hard surface, so please check if this hotel offers that comfort”. Now without even uttering a word about the mattress type, prospect B has specified his/her requirement to have a hard mattress and is not sure if this hotel provides a hard mattress. Now this becomes a topic of discussion among them and a very specific requirement for prospect B. They are now left with only the option to either call the hotel or review all comments to get information about their specific requirement. This now becomes a time-consuming process and leads to the fact about whether to trust on verbally confirm by calling the hotel staff or not. At times this delays the purchase and impacts preferences due to non-availability of good or services. Such scenarios greatly impact the decision of online purchases, goods and services.

Further, the system will continuously learn from the discussion between prospect A and B and understand their requirement using AI NLP. This input is then used to generate a nonstandard product specification for that specific prospect. In this case “mattress type” becomes a new nonstandard product specification for the specific user on the e-commerce platform.

In some embodiments of the present invention, the system uses existing feedbacks, reviews, and relevant references from other consumers to generate type and index value for the nonstandard product specification using data science service like cluster analysis.

According to some embodiments of the present invention, the items described in the above paragraph will now be discussed as an example in the following paragraph.

Returning to the hotel example described above, once the nonstandard product specification (in this case “mattress type”) is determined, the system will go through either a predefined item description for this type of information or will search all the reviews and feedback comments to match the criteria which describes the mattress material or type. Review comments such as “the bed was soft and comfortable”, “got some relief from backache after visiting this hotel”, “a hard bed was provided during my visit”, “a single bed option is available, and it is a good mattress”, “bed mattress quality was not great, it was very hard and resulted in back pain”, etc. Based on the analysis of such comments, the system will classify the comments into specific values using intelligence and determine the probable values of this nonstandard product specification such as, “hard mattress available”, “soft mattress available”, “single bed with hard mattress available”, etc., and the index associated with them based on the type and number of feedbacks.

Some embodiments of the present invention may include one, or more, of the following operations, features, characteristics and/or advantages: (i) the type and index value for nonstandard product specifications will be dynamically displayed to the specific prospect without making it available for generalized visibility; (ii) the possible types and values generated will be linked to specific nonstandard product specifications as its possible types and values; (iii) the combination of this newly generated nonstandard product specification, along with its possible types and values, will be visible to only that specific consumer who talked about it and is interested in it; (iv) any other prospect who is looking or reviewing this product at the same time will not be able to view this newly identified nonstandard product specification as his/her context may be different; and/or (v) the prospects decision of purchase is not based on this product specification.

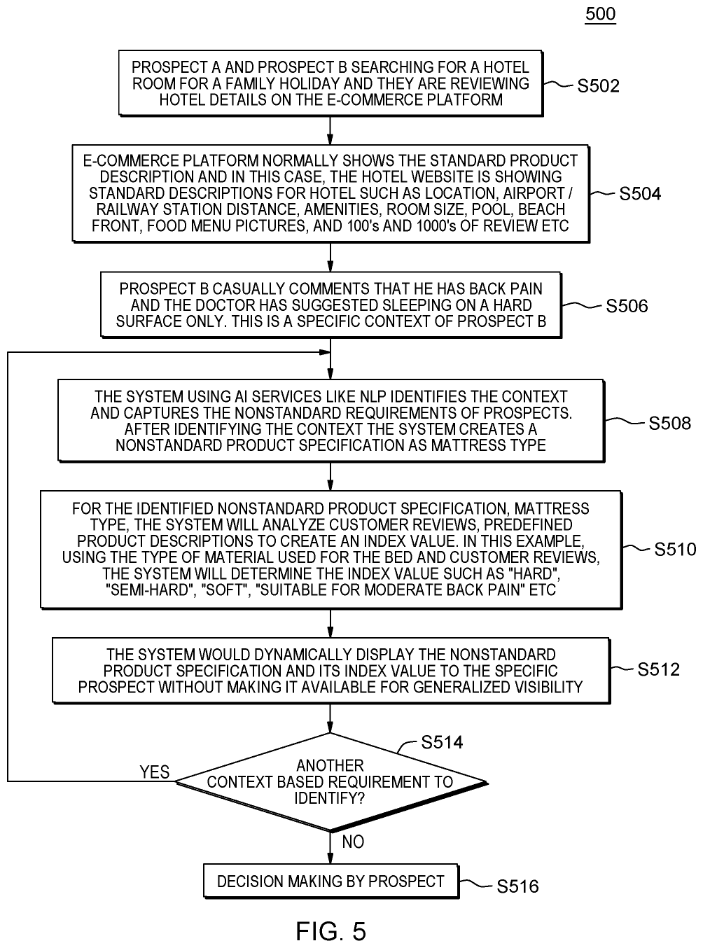

As shown, FIG. 5, flowchart 500 includes operations: S502, S504, S506, S508, S510, S512, S514, and S516. Processing flow among and between the operations listed in Flowchart 500 is indicated by arrows.

Some embodiments of the present invention may include one, or more, of the following operations, features, characteristics and/or advantages: (i) generates a nonstandard product specification by understanding the user's current context and identified requirements; (ii) discloses a step of using existing feedbacks, reviews, and relevant references from other consumers to generate type and index value for the nonstandard product specification using data science service such as cluster analysis; (iii) discloses a step wherein the type and index value for nonstandard product specifications are dynamically displayed to the specific prospect without making it available for generalized visibility; (iv) includes customer's predefined profile parameters; (v) is solely based on current context of the users, irrespective of their past or future liking; (vi) discloses a step to learn the prospects requirement using AI services like NLP in real-time from the current context during the product evaluation on an e-commerce platform; (vii) uses the requirement noted in (vi) above to create a nonstandard product specification to be displayed; and/or (viii) includes a method for an advanced e-commerce platform to display dynamically nonstandard product specifications based on user context and the need to improve customer satisfaction.

Some embodiments of the present invention may include one, or more, of the following operations, features, characteristics and/or advantages: (i) the system learns the prospects real-time requirement from the current context during product review; (ii) the system identifies the need of a nonstandard situation-based product specification; (iii) the system compares nonstandard situation-based product specification information verses feedback, reviews, and relevant references from other consumers to generate a type and index value for a nonstandard situation-based product specification; and/or (iv) the type and index value for nonstandard situation-based product specifications will be displayed to the specific prospect interested in that specification without making it available for generalized visibility for other prospects reviewing the same product at the same time.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

And/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

1. A computer-implemented method (CIM) comprising:
receiving a product specification data set that includes information indicative a full version of a product specification, with the full version of the product specification including information indicative of: (i) an identification of a first product, (ii) an identification of a plurality of parameters associated with the first product, and (iii) for each parameter of the plurality of parameters, a respectively corresponding parameter value that characterizes the first product with respect to the given parameter;
receiving, from a user and through a communication network, a user request for the product specification;
receiving a user discussion data set including information indicative of statements communicated in discussion, between the user and at least one third party, relating to a prospective possible purchase of the first product;
determining, by machine logic and based at least in part on the user discussion data set, a parameter-of-interest relating to the first product;
determining that the parameter-of-interest is not included in the plurality of parameters;
determining a first parameter value for the parameter-of-interest for the first product; and
assembling, by machine logic, a customized version of the product specification that includes the first parameter value;
wherein the first product is a mattress, the parameter-of-interest is back pain relief and the first parameter value is indicative of a degree of back relief afforded by the first product; and
further wherein the user discussion data set includes a reference to back pain.

2. The CIM of claim 1 further comprising:
sending, over the communication network and to a device of the user, the customized version of the product specification.

3. The CIM of claim 2 further comprising:
displaying, on a display of the device of the user, the customized version of the product specification.

4. The CIM of claim 1 wherein the determination of the first parameter value includes parsing user comments relating to the first product to determine user comments relating to the parameter-of-interest and/or the first parameter value.

5. The CIM of claim 1 wherein the CIM is implemented on and through an e-commerce platform.

6. The CIM of claim 5 further comprising:
receiving, from the user and over the communication network, an order to purchase the first product.

7-30. (canceled)
